(19) United States
(12) Patent Application Publication
(10) Pub. No.: US 2009/0051844 A1
(43) Pub. Date: Feb. 26, 2009

(54) Defect repairing method of liquid crystal display and signal transmission method of source driver and timing controller thereof

(75) Inventors: Chien-Chun Chen, Sinshih Township (TW); Ying-Lieh Chen, Sinshih Township (TW); Lin-Kai Bu, Sinshih Township (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 12/000,397

(22) Filed: Dec. 12, 2007

(30) Foreign Application Priority Data
Aug. 21, 2007 (TW) 096130967

(51) Int. Cl. G02F 1/1333

(52) U.S. Cl. 349/54

(57) ABSTRACT

A liquid crystal display (LCD) includes a controller, a source driver, first and second data lines and a data transmission path. The controller outputs first and second image data, and the source driver receives and outputs the first and second image data. The source driver includes first and second data channel circuits and a first repair channel circuit. The first and second data channel circuits respectively output first and second sub-pixel data. The first repair channel circuit is coupled to the controller to receive first repairing data. The first and second data lines are respectively coupled to the first and second data channel circuits to receive the first and second sub-pixel data. The data transmission path includes a redundant line, which is for coupling the first repair channel circuit to one of the first and second data lines, and interlaces with the first and second data lines.

This application claims the benefit of Taiwan application Serial No. 0 96130967, filed Aug. 21, 2007, the subject matter of which is incorporated herein by reference.

### BACKGROUND OF THE INVENTION

1. Field of the Invention

The invention relates in general to a liquid crystal display (LCD), and more particularly to a LCD having a repair channel through which an open defect of the LCD can be repaired.

2. Description of the Related Art

In a liquid crystal panel of a conventional LCD, multiple redundant lines have to be provided so that data repairing can be performed through the redundant line and the opened data line by way of laser welding when the data line of the LCD has an open defect.

FIG. 1 (Prior Art) is a schematic illustration showing an operation of repairing an open defect of a data line in a conventional LCD 100. In the LCD 100, when a data line 102 has an open defect, the data line 102 forms a normal end 102a and a to-be-repaired end 102b. At this time, the operator connects the normal end 102a and the to-be-repaired end 102b to redundant lines 104a and 104b respectively by way of laser welding. Thus, sub-pixel data outputted from the corresponding data channel in a source driver 106 may be outputted to the to-be-repaired end 102b to drive a sub-pixel corresponding to the to-be-repaired end 102b through a data transmission path formed by the redundant lines 104a and 104b and a repair operational amplifier 108. Thus, the operation of repairing the open defect of the data line can be achieved.

With regard to the data channel for driving the data line having the open defect, however, the data transmission path substantially forms the layout having a length greater than that of the data line, and the layout corresponding forms a larger drive loading of the data channel. Consequently, the data channel tends to have the problem of the insufficient data driving ability. When the LCD panel is developed toward the large-scale size, the number of redundant lines and the length of the layout path required in the conventional LCD also increase. Therefore, the problem of the data driving ability becomes more obvious. Meanwhile, the increased number of the redundant lines and the lengthened layout path cause the number of times of laser welding to be increased. Thus, the cost of the LCD is increased.

### SUMMARY OF THE INVENTION

The invention is directed to a liquid crystal display (LCD) and a data transmission method thereof. The LCD advantageously has the fewer redundant lines, the shorter data transmission path formed after repair, the fewer times of laser welding required for the repair, and the lower cost.

According to a first aspect of the present invention, a liquid crystal display (LCD) including a controller, a source driver, first and second data lines and a data transmission path is provided. The controller is for outputting at least one first and second image data. The source driver is for receiving the first and second image data and outputting corresponding first and second sub-pixel data. The source driver includes a first data channel circuit for outputting the first sub-pixel data, a second data channel circuit for outputting the second sub-pixel data, and a first repair channel circuit, coupled to the controller, for receiving first repairing data. The first and second data lines are respectively coupled to the first and second data channel circuits and are for receiving the first and second sub-pixel data. The data transmission path includes a redundant line and is for selectively coupling the first repair channel circuit to one of the first and second data lines. The redundant line interlaces with the first and second data lines.

According to a second aspect of the present invention, a defect repairing method of a liquid crystal display (LCD) is provided. The LCD includes a source driver, a data line coupled to the source driver along a first direction, and a redundant line interlacing with the data line along a second direction. The source driver includes a data channel circuit and a repair channel circuit for respectively outputting sub-pixel data and repairing the sub-pixel data. The redundant line is electrically coupled to the repair channel circuit, the data line includes a normal portion and a to-be-repaired portion isolated from each other, and the normal portion is coupled to the data channel circuit. The defect repairing method includes the steps of: electrically connecting the redundant line to the to-be-repaired portion; and outputting the repairing sub-pixel data to the to-be-repaired portion. The repairing sub-pixel data is substantially the same as the sub-pixel data.

According to a third aspect of the present invention, a source driver applied to a liquid crystal display (LCD) is provided. The LCD includes first and second data lines, a controller and a data transmission path. The controller is for outputting first image data, second image data and first repairing data, and the data transmission path includes a redundant line interlacing with the data lines. The source driver includes a first data channel circuit, a second data channel circuit and a first repair channel circuit. The first data channel circuit is for receiving the first image data and outputting first sub-pixel data to the first data line. The second data channel circuit is for receiving the second image data and outputting second sub-pixel data to the second data line. The first repair channel circuit is for receiving the first repair signal and outputting first repairing sub-pixel data to the data transmission path.

According to a fourth aspect of the present invention, a signal transmission method of a timing controller applied to a liquid crystal display (LCD) is provided. The method includes the steps of: selectively inserting repairing data before or after a plurality of pieces of image data; and sequentially outputting the repairing data and the pieces of image data, wherein the repairing data is the same as one of the pieces of image data.

According to a fifth aspect of the present invention, a liquid crystal display (LCD) including a source driver, first and second data lines and a data transmission path is provided. The source driver is for receiving first and second image data and outputting corresponding first and second sub-pixel data. The source driver includes a first data channel circuit for outputting the first-sub-pixel data, a second data channel circuit for outputting the second sub-pixel data, and a first repair channel circuit for receiving first repairing data. The repair channel circuit includes a latch, a digital-to-analog converter and an output buffer. The first and second data lines are respectively coupled to the first and second data channel circuits and are for receiving the first and second sub-pixel data. The data transmission path includes a redundant line and is for selectively coupling the first repair channel circuit to one of the first and second data lines. The redundant line interlaces with the first and second data lines.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing an operation of repairing an open defect of a data line in a conventional LCD.

FIG. 2 is a circuit diagram showing a LCD according to a first embodiment of the invention.

FIG. 3 is a flow chart showing a data transmission method according to the first embodiment of the invention.

FIG. 4 is a flow chart showing a signal transmission method of a timing controller according to the invention.

FIG. 5 is another circuit diagram showing the LCD according to this embodiment of the invention.

FIG. 6 is another circuit diagram showing the LCD according to this embodiment of the invention.

FIG. 7 is a circuit diagram showing a LCD according to a second embodiment of the invention.

FIG. 8 is a circuit layout diagram showing a source driver of FIG. 7.

FIG. 9 is another circuit layout diagram showing the source driver of FIG. 7.

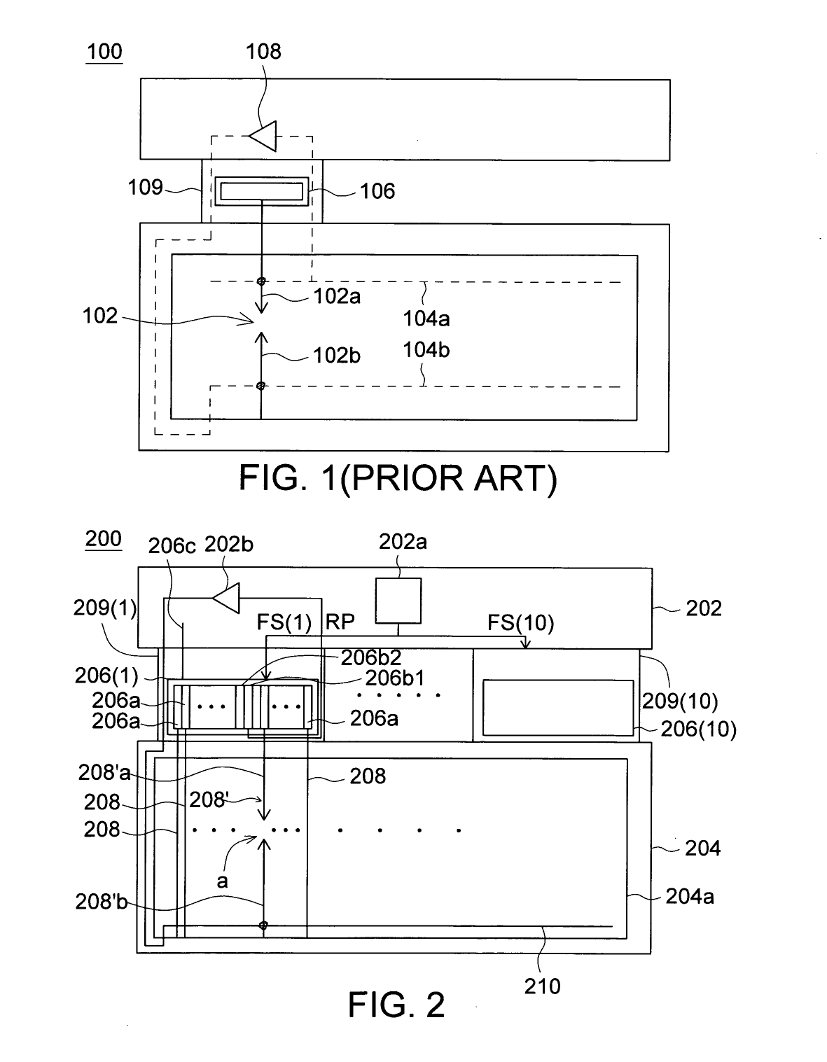

### DETAILED DESCRIPTION OF THE INVENTION

When the LCD of the invention adopts source drivers with the greater number of channel circuits, repair channel circuits may be designed in the source drivers with the greater number of channel circuits. Consequently, when any data line in the LCD of the invention has an open defect, the opened data line can be repaired through the repair channel circuit.

### First Embodiment

FIG. 2 is a circuit diagram showing a LCD 200 according to a first embodiment of the invention. Referring to FIG. 2, the LCD 200 includes a printed circuit board (PCB) 202, a substrate 204, source drivers 206(1) to 206(10) and flexible printed circuits (FPCs) 209(1) to 209(10). The substrate 204 includes a LCD panel 204a, which includes multiple data lines 208, redundant lines 210 and a pixel array (not shown). The LCD panel 204a has the resolution of 1280×1024 pixels, for example. Each pixel includes red, green and blue (RGB) sub-pixels, for example. The PCB 202 includes a controller and a repair operational amplifier 202b, wherein the controller is a timing controller (TCON) 202a. The FPCs 209(1) to 209(10) respectively have the source drivers 206(1) to 206(10).

The timing controller 202a outputs image data FS(1) to FS(10) to the source drivers 206(1) to 206(10). The source drivers 206(1) to 206(10) are also referred to as source driver circuits and respectively receive the image data FS(1) to FS(10), and output multiple pieces of sub-pixel data. The image data FS(1) to FS(10) include, for example, corresponding pixel data corresponding to a whole specific row of pixels (1280) in the LCD panel 204a.

Each of the source drivers 206(1) to 206(10) of this embodiment includes 386 channel circuits. Taking the source driver 206(1) as an example, it includes 384 data channel circuits 206a and a repair channel circuit 206b1. One end of the data channel circuit 206a is coupled to the timing controller 202a to receive the corresponding sub-pixel data in the image data FS(1). The other end of the data channel circuit 206a is coupled to the corresponding data line 208. The data channel circuit 206a outputs the sub-pixel data to the corresponding data line 208 in order to drive the corresponding sub-pixel on the data line 208.

The repair channel circuit 206b1 coupled to the data transmission path receives the repairing data RP and then outputs the repairing sub-pixel data through the data transmission path. The data transmission path includes a redundant line 210 and the repair operational amplifier 202b. The repair channel circuit 206b1 is coupled to an input terminal of the operational amplifier 202b. An output terminal of the repair operational amplifier 202b is coupled to the redundant line 210. The redundant line 210 interlaces with the data lines 208. For example, the redundant line 210 interlaces with each of the data lines 208, and the redundant line 210 and the data line 208 may further be selectively electrically connected to each other in response to an operation event of an operator.

When the data line 208, such as a data line 208′, in the LCD panel 204a has an open defect, as shown by the arrow “a” in FIG. 2, the data line 208′ forms a normal end 208′a and a to-be-repaired end 208′b. The normal end 208′a is a node coupled to the data line 208′ and the source driver 206(1). For example, the data line 208′ is the data line for driving the red sub-pixel of the 100^{th} column of pixels, and the open defect occurs at the position of the 500^{th} sub-pixel corresponding to the 100^{th} column of red sub-pixels in the data line 208′. The sector of the data line 208′ for driving the 1^{st} to 499^{th} red sub-pixels of the 100^{th} column of red sub-pixels is the normal end 208′a. The sector of the data line 208′ for driving the 500^{th} to 1024^{th} red sub-pixels of the 100^{th} column of red sub-pixels is the to-be-repaired end 208′b.

When this condition occurs, the operator performs the corresponding operation event to couple the redundant line 210 to the to-be-repaired end 208′b of the data line 208′. Thus, the repair channel circuit 206b1 can be coupled to the to-be-repaired end 208′b through the data transmission path including the redundant line 210 and the repair operational amplifier 202b. The operator further controls the timing controller 202a to provide the repairing data RP to the source driver 206(1) through programming operations, wherein the repairing data RP is substantially equal to the image data FS(1). The repair channel circuit 206b1 receives the repairing sub-pixel data of the repairing data RP corresponding to the data line 208′, and outputs the repairing sub-pixel data to the to-be-repaired end 208′b through the data transmission path. The repairing sub-pixel data is substantially equal to the sub-pixel data, which is outputted to the data line 208′ from the corresponding data channel circuit 206a in the source driver 206(1). Thus, the sub-pixel data, which is originally provided to the to-be-repaired end 208′b to drive the corresponding sub-pixel can be provided to the to-be-repaired end 208′b through the operation. Consequently, the effect of repairing the data line 208′ can be achieved effectively by driving the sub-pixel at the to-be-repaired end 208′b according to the corresponding sub-pixel data.

For example, the timing controller 202a simultaneously provides the image data FS(1) to FS(10) to the corresponding source drivers 206(1) to 206(10) in an enabled period of a data enable signal. The timing controller 202a of this embodiment is programmed and controlled to output the repairing data RP to the source driver 206(1) after outputting the image data FS(1) to FS(10).

The source driver 206(1) further has a channel control pin (ENREACH pin) 206c. The operator may effectively enable the repair channel circuit 206b1 through the channel control pin 206c so that the repairing operation can be performed. In this embodiment, the source driver 206(1) including one repair channel circuit 206b1 and one data transmission path is described as an example. However, the source driver 206(1) is not limited to the inclusion of one repair channel circuit and one data transmission path. Instead, the source driver 206(1) may include two or more than two repair channel circuits and data transmission paths in order to repair two or more than two data lines having the open defects, respectively. For example, the source driver 206(1) of this embodiment further includes a repair channel circuit 206b2, which can repair any data line having the open defect in the data line 208 according to the operation substantially the same as that of the repair channel circuit 206b1.

In this embodiment, the repair channel circuit 206b1 of the source driver 206(1) may be coupled to the to-be-repaired end 208′b of the data line 208′ having the open defect through the data transmission path including the repair operational amplifier 202b and the redundant line 210. The timing controller 202a of this embodiment may further be programmed to provide the repairing data RP to the source driver 206(1) so that the repairing sub-pixel data can be outputted to the to-be-repaired end 208′b through the data transmission path and corresponding through the repair channel circuit 206b1. The repairing sub-pixel data is substantially equal to the sub-pixel data, which is originally outputted to the data line 208′ through the corresponding data channel circuit 206a. Consequently, the LCD 200 of this embodiment may achieve the effect of repairing the data line 208′ through one redundant line 210 and one laser welding process. Thus, the LCD 200 of this embodiment can effectively reduce the number of the redundant lines, reduce the number of times of laser welding and shorten the length of the redundant line layout.

In addition, the normal end 208′a and the to-be-repaired end 208′b are respectively driven through the corresponding data channel circuit 206a, and through the repair channel circuit 206b1 and the data transmission path. Thus, compared with the conventional LCD, the LCD 200 of this embodiment can effectively decrease the drive loading of the corresponding data channel circuit 206a.

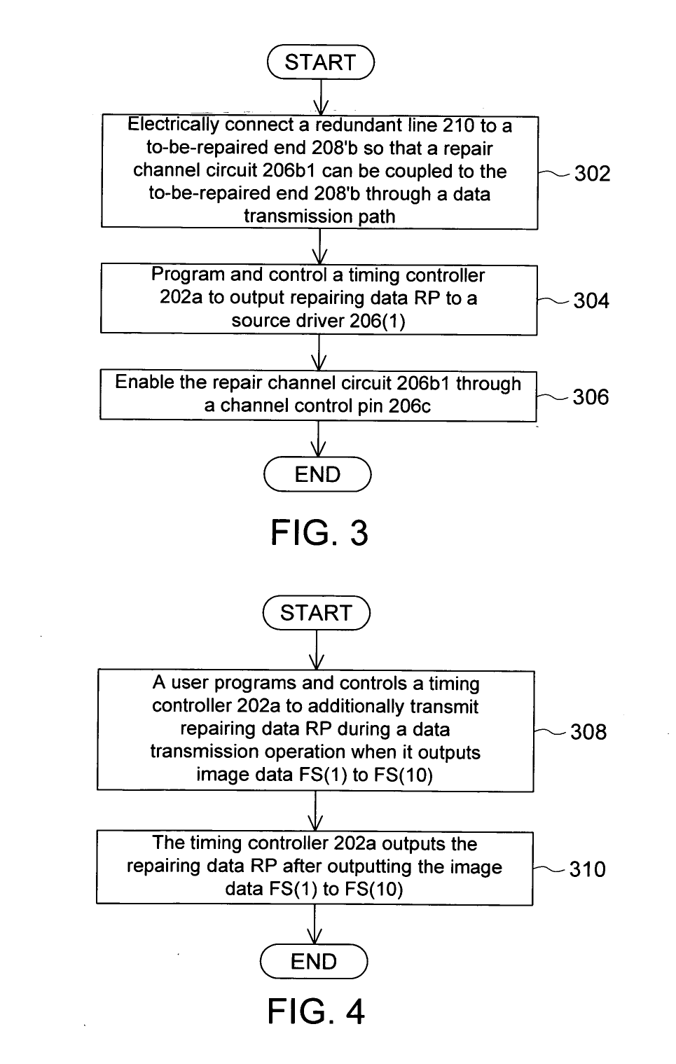

FIG. 3 is a flow chart showing a data transmission method according to the first embodiment of the invention. First, as shown in step 302, the redundant line 210 is electrically connected to the to-be-repaired end 208′b so that the repair channel circuit 206b1 can be coupled to the to-be-repaired end 208′b through the data transmission path. The redundant line 210 may be electrically connected to the to-be-repaired end 208′b by way of laser welding. Thereafter, as shown in step 304, the timing controller 202a is programmed and controlled to output the repairing data RP to the source driver 206(1). The method may further include, after the step 304, the step 306 of enabling the repair channel circuit 206b1 through the channel control pin 206c. The repair channel circuit 206b1 receives the repairing data RP and correspondingly outputs the repairing sub-pixel data to the to-be-repaired end 208′b through the data transmission path. Thus, the repairing sub-pixel data can be outputted to the to-be-repaired end 208′b through the repair channel circuit 206b1 and the data transmission path in order to drive the corresponding sub-pixel. The step 306 may also follow the step 302.

FIG. 4 is a flow chart showing a signal transmission method of a timing controller according to the invention. First, as shown in step 308, the user programs and controls the timing controller 202a to additionally transmit the repairing data RP during the data transmission operation when it outputs the image data FS(1) to FS(10). For example, the timing controller 202a outputs the repairing data RP to the source driver 206(1) after outputting the image data FS(1) to FS(10) to the source drivers 206(1) to 206(10), respectively. Next, as shown in step 310, the timing controller 202a outputs the repairing data RP after outputting the image data FS(1) to FS(10), wherein the repairing data RP is substantially equal to the image data FS(1).

In the operation, the operation event performed by the operator is the operation of laser welding the redundant line 210 to the to-be-repaired end 208′b, for example, so that the redundant line 210 and the to-be-repaired end 208′b are coupled to each other. The timing controller 202a of this embodiment is a one time programmable (OTP) controller. Thus, when the LCD panel 204a has the open defect of the data line when it is manufactured, the timing controller 202a can be programmed and controlled so that the timing controller 202a outputs the repairing data RP to the source driver 206(1), and the corresponding data line 208′ can be repaired.

In this embodiment, the source drivers 206(1) to 206(10) each including the 386 channel circuits for driving the LCD panel 204a having the resolution substantially equal to 1280*1024 are described as an example. However, the LCD 200 and the data transmission method according to this embodiment are not restricted to the above-mentioned resolution and the structure of the sub-pixel of the pixel unit, the number of channel circuits of each of the source drivers 206(1) to 206(10) is not restricted to 386, and the number of the repair channel circuits and the number of the data channel circuits are also not restricted. For example, each of the source drivers 206(1) to 206(10) may include 390 channel circuits including 6 repair channel circuits and 384 data channel circuits. In this embodiment, the condition that the source drivers 206(1) to 206(10) are connected to one repair operational amplifier is described as an example. However, the source drivers 206(1) to 206(10) may further be connected to two or more than two repair operational amplifiers, respectively.

In this embodiment, the condition that the data transmission path includes the repair operational amplifier 202b and the redundant line 210 is described as an example. However, the data transmission path of this embodiment is not restricted to the inclusion of the repair operational amplifier 202b and the redundant line 210, and an output buffer for enhancing the data driving ability of the repair channel circuit 206b1 may also be additionally provided according to the length of the data transmission path.

In the example of this embodiment, the data line 208′ in the source driver 206(1) has the open defect and the operator repairs the open defect through the repair channel circuit 206b1 of the source driver 206(1). However, the repairing operations of other source drivers 206(2) to 206(10) may also be analogized and obtained according to the repairing operation of the source driver 206(1). The circuit structures of the source drivers 206(2) to 206(10) may also be analogized and obtained according to the description of the source driver 206(1).

In this illustrated embodiment, the source driver 206(1) only includes the channel control pin 206c, through which the repair channel circuit 206b1 is enabled to repair the open defect of the data line of this embodiment. However, the repair channel circuit 206b1 of this embodiment may also be enabled by the timing controller 202a to repair the open defect of the data line in this embodiment. The repair channel circuits 206b1 and 206b2 of this embodiment are disposed between the data channel circuits 206a, for example. In addition, when the repair channel circuits 206b1 and 206b2 are disposed at the middle of all the channel circuits of the source driver 206, the LCD 200 of this embodiment has the better effect.

In this illustrated embodiment, the timing controller 202a outputs the repairing data RP to the source driver 206(1), after outputting the image data FS(1) to FS(10), so as to repair the data line 208′ of this embodiment. However, the timing controller 202a of this embodiment is not limited to the feature of outputting the repairing data RP after outputting the image data FS(1) to FS(10). Instead, the timing controller 202a may also output the repairing data RP before outputting the image data FS(1) to FS(10).

The source driver 206(1) of this embodiment includes the 386 channel circuits having substantially the same structure, for example. For example, the source driver 206(1) has the circuit structure substantially similar to that of the conventional channel circuit, and includes a latch, a digital-to-analog converter and an output buffer.

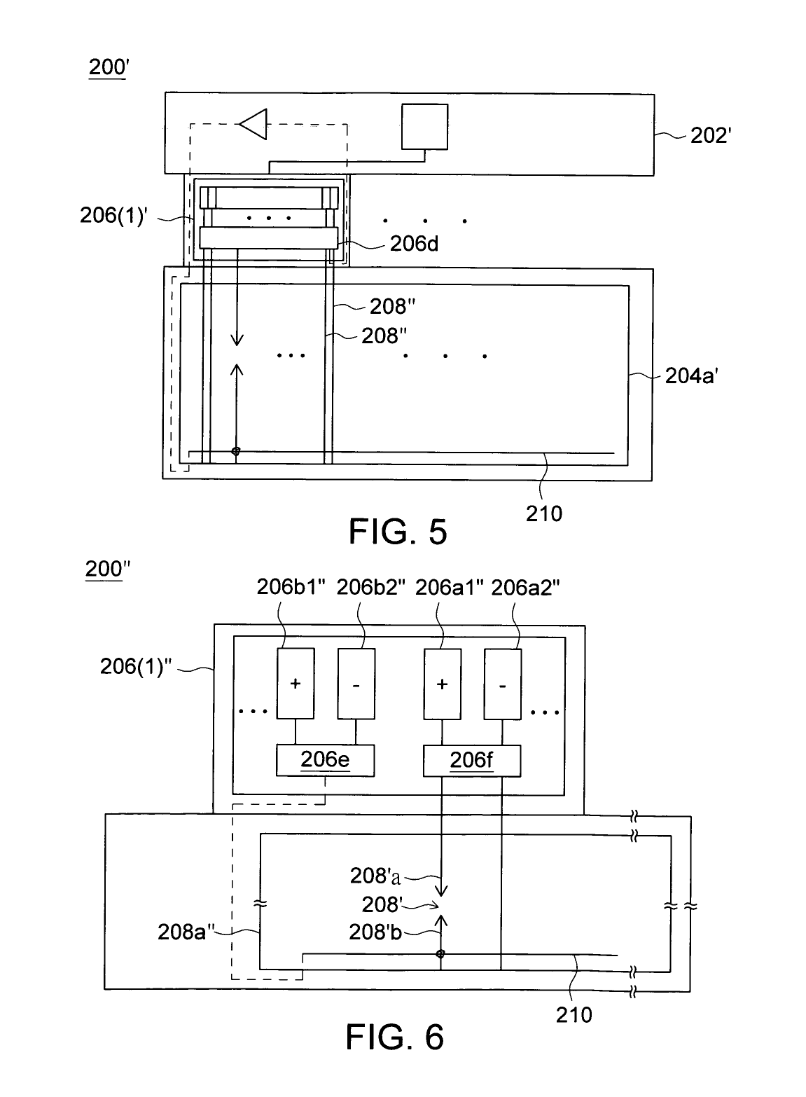

In this illustrated embodiment, the source driver 206(1) includes the data channel circuit 206a and the repair channel circuits 206b1 and 206b2. However, the source driver 206(1) of this embodiment is not limited to the inclusion of only the channel circuit, but may also include other hardware devices. For example, a source driver 206′(1) further includes a channel selecting circuit 206d, which is coupled to a data channel circuit 206a′ and repair channel circuits 206b1′ and 206b2′ of the source driver 206′(1), and provides the data outputted from the data channel circuit 206a′ and the repair channel circuits 206b1′ and 206b2′ to a corresponding data line 208″ and the corresponding data transmission path in a LCD panel 204a′ in response to a selection signal (not shown), as shown in FIG. 5.

FIG. 6 is another circuit diagram showing the LCD according to this embodiment of the invention. As shown in FIG. 6, data channel circuits 206a1″ and 206a2″ are paired to output the sub-pixel data with the opposite polarities, and repair channel circuits 206b1″ and 206b2″ are also paired to output the repairing data with the opposite polarities. The polarity of the sub-pixel data is defined with respect to the data polarity of the common voltage of a LCD panel 204a″. A source driver 206(1)″ further includes multiple channel selecting circuits 206e and 206f. The channel selecting circuit 206f receives the sub-pixel data of the corresponding two data channel circuits 206a1″ and 206a2″, selects and outputs one of them to the corresponding first data line, and selects and outputs the other of them to the corresponding second data line. The channel selecting circuit 206e receives the repairing data of the repair channel circuits 206b1″ and 206b2″ and selects and outputs one of them to the corresponding data transmission path. When the sub-pixel data outputted from the channel selecting circuit 206f is correspondingly inputted to the data line 208′ with the open defect, the repairing data outputted from the channel selecting circuit 206e and the sub-pixel data outputted from the channel selecting circuit 206f to the data line 208′ have substantially the same polarity. For example, when the sub-pixel data on the data line 208′ has the positive polarity, the channel selecting circuit 206e selects the repairing data with the positive polarity (e.g., the repairing data in the repair channel circuit 206b1″) and outputs the repairing data to the to-be-repaired end 208′b through the data transmission path.

In the LCD of this embodiment, the repair channel circuit may provide the repairing data to the to-be-repaired end of the data line having the open defect through the data transmission path including the redundant line and the repair operational amplifier. Thus, compared with the conventional LCD, the LCD of this invention can effectively achieve the effect of repairing the data line through one redundant line and one laser welding process so that the number of the redundant lines can be advantageously decreased, the number of times of laser welding can be advantageously decreased, and the length of the redundant line layout may be advantageously shortened.

In addition, the normal end of the data line having the open defect is driven by the corresponding data channel circuit, and the to-be-repaired end is driven by the repair channel circuit through the data transmission path in the LCD of this embodiment. Compared with the conventional LCD, the LCD of this embodiment may further effectively and advantageously decrease the drive loading of the corresponding data channel circuit.

### Second Embodiment

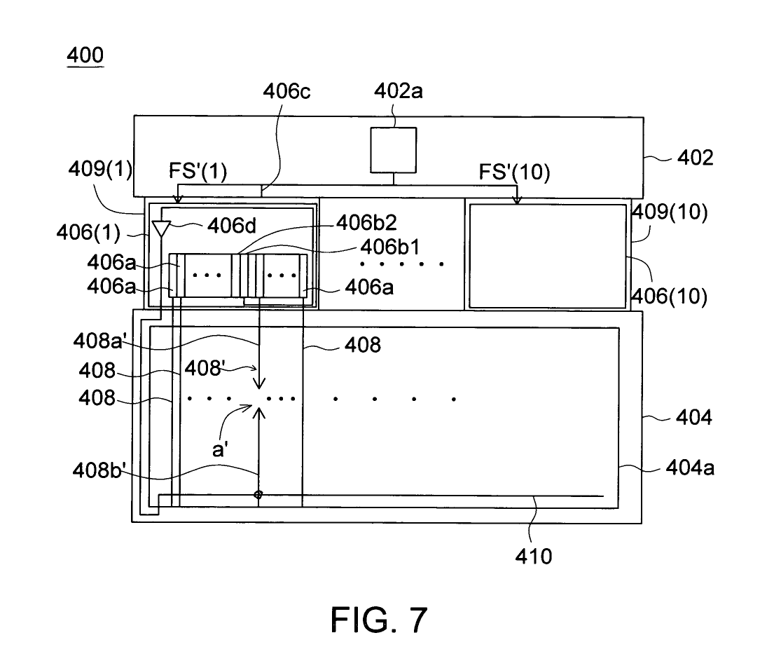

FIG. 7 is a circuit diagram showing a LCD 400 according to a second embodiment of the invention. As shown in FIG. 7, what is different from FIG. 2 is that a repair operational amplifier 406d of the LCD 400 is designed in a source driver 406(1).

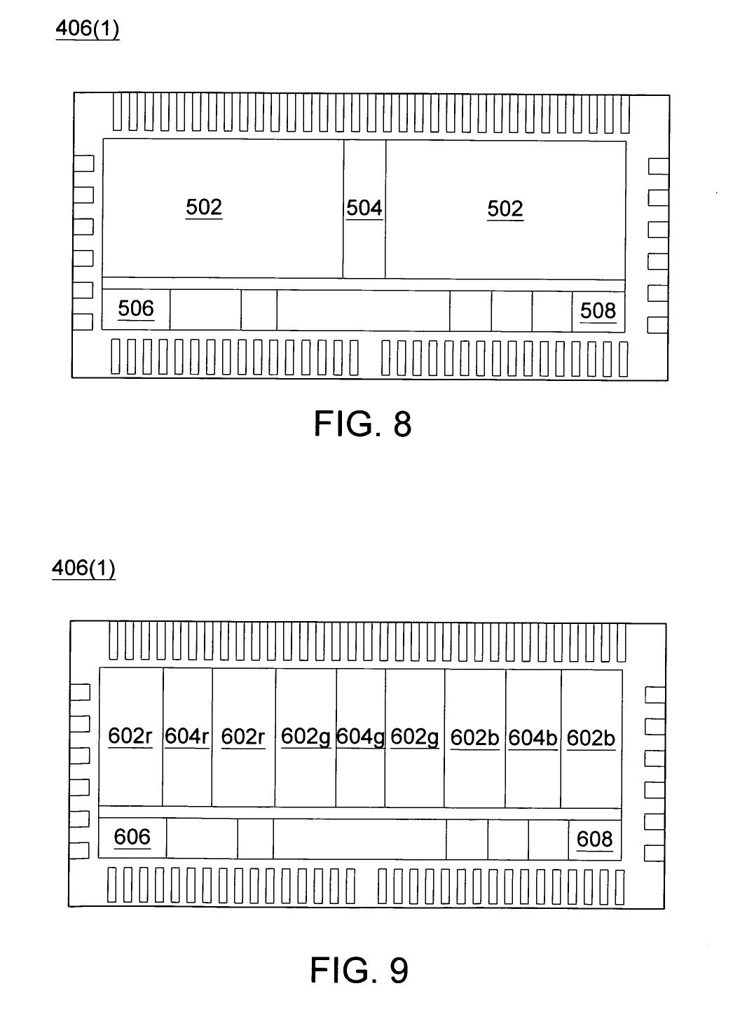

FIG. 8 is a circuit layout diagram showing the source driver 406(1) of FIG. 7. As shown in FIG. 8, the source driver 406(1) includes 386 channel circuits including 384 data channel circuits 502 and two repair channel circuits 504. The repair channel circuits 504 are located at a middle of the 384 data channel circuits 502, for example. The source driver 406(1) includes two repair operational amplifiers 506 and 508. In this embodiment, only the circuit layout diagram of the source driver 406(1) is illustrated. However, the structures of source drivers 406(2) to 406(10) may be analogized according to the structure of the source driver 406(1).

FIG. 9 is another circuit layout diagram showing the source driver 406(1) of FIG. 7. As shown in FIG. 9, the source driver 406(1) includes 390 channel circuits including 384 data channel circuits 602 and six repair channel circuits 604. The 384 data channel circuits include, for example, 128 red data channel circuits 602r, 128 green data channel circuits 602g and 128 blue data channel circuits 602b. The six repair channel circuits 604 include two red repair channel circuits 604r, two green repair channel circuits 604g and two blue repair channel circuits 604b. The two red repair channel circuits 604r, the two green repair channel circuits 604g and the two blue repair channel circuits 604b are respectively located at the middles of the 128 red data channel circuits 602r, the 128 green data channel circuits 602g and the 128 blue data channel circuits 602b. The red, green and blue repair channel circuits 604r, 604g and 604b can repair the open defects on the data lines corresponding to the red, green and blue data channel circuits 602r, 602g and 602b.

The source driver 406(1) also includes two repair operational amplifiers 606 and 608. In this embodiment, only the circuit layout diagram of the source driver 406(1) is depicted. However, the structures of the source drivers 406(2) to 406(10) may be analogized according to the structure of the source driver 406(1).

According to this embodiment, it is obtained that the LCD of the invention may also select the source driver having the build-in repair operational amplifier so that the same repair effect of the data line can be obtained.

The LCD of the invention adopts the source driver having the greater number of channel circuits so that two repair channel circuits may be designed in each source driver. When a certain data line of the LCD has the open defect, the LCD of the invention outputs the repairing data to the repair channel circuit through the timing controller, and the repair channel circuit provides the repairing data to the corresponding to-be-repaired end through the data transmission path including the repair operational amplifier and the redundant line to complete the repair. Therefore, the LCD of the invention can effectively solve the drawbacks that the number of the redundant lines is great, the path of the redundant line layout is long, and the required number of times of laser welding is great in the conventional LCD, and at the same time improve the problem that the conventional LCD has the increased loading of the redundant line due to the too long path of the redundant line layout.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD), comprising:
a controller for outputting at least one first and second image data;
a source driver for receiving the first and second image data and outputting corresponding first and second sub-pixel data, the source driver comprising:
a first data channel circuit for outputting the first sub-pixel data;
a second data channel circuit for outputting the second sub-pixel data; and
a first repair channel circuit, coupled to the controller, for receiving first repairing data;
first and second data lines, respectively coupled to the first and second data channel circuits, for receiving the first and second sub-pixel data; and
a data transmission path, comprising a redundant line, for selectively coupling the first repair channel circuit to one of the first and second data lines, wherein the redundant line interlaces with the first and second data lines.

2. The LCD according to claim 1, wherein the first data line comprises first and second wires isolated from each other, the first wire is coupled to the first data channel circuit, and the second wire is coupled to the first repair channel circuit through the data transmission path.

3. The LCD according to claim 1, wherein the first repairing data is substantially the same as the first image data.

4. The LCD according to claim 1, wherein,
the first repair channel circuit outputs first repairing sub-pixel data to the data transmission path;
the first repairing sub-pixel data is substantially the same as the first sub-pixel data.

5. The LCD according to claim 1, wherein the controller controls the first repair channel circuit to output first repairing sub-pixel data substantially the same as the first sub-pixel data.

6. The LCD according to claim 5, wherein the redundant line is selectively coupled to the first and the second data lines by way of laser-welding.

7. The LCD according to claim 1, wherein the redundant line is located above the data lines.

8. The LCD according to claim 1, wherein when the first data line has an open defect, the first data line comprises a normal portion coupled to the first data channel circuit, and a to-be-repaired portion coupled to the data transmission path.

9. The LCD according to claim 1, wherein the data transmission path comprises an output buffer.

10. The LCD according to claim 9, wherein the output buffer and the source driver circuit are integrated in a chip.

11. The LCD according to claim 1, wherein the first repair channel circuit is enabled by the controller.

12. The LCD according to claim 1, wherein the source driver further comprises a channel selecting circuit, coupled to the first and second data channel circuits, for receiving the first and second sub-pixel data, selectively outputting one of the first and second sub-pixel data through one of the first and second data lines, and outputting the other of the first and second sub-pixel data through the other of the first and second data lines.

13. The LCD according to claim 1, wherein the source driver further comprises a second repair channel circuit and a channel selecting circuit, the first and second repair channel circuits respectively output first and second repairing sub-pixel data, and selectively output one of the first and second repairing sub-pixel data to the redundant line through the channel selecting circuit.

14. A defect repairing method of a liquid crystal display (LCD), the LCD comprising a source driver, a data line coupled to the source driver along a first direction, and a redundant line interlacing with the data line along a second direction, wherein the source driver comprises a data channel circuit and a repair channel circuit for respectively outputting sub-pixel data and repairing sub-pixel data, wherein the redundant line is electrically coupled to the repair channel circuit, the data line comprises a normal portion and a to-be-repaired portion isolated from each other, and the normal portion is coupled to the data channel circuit, the defect repairing method comprising the steps of:
electrically connecting the redundant line to the to-be-repaired portion; and
outputting the repairing sub-pixel data to the to-be-repaired portion, wherein the repairing sub-pixel data is substantially the same as the sub-pixel data.

15. The method according to claim 14, wherein the connecting step is to couple the redundant line to the to-be-repaired portion by way of laser welding.

16. The method according to claim 14, wherein the step of outputting the repairing sub-pixel data to the to-be-repaired portion further comprises:
outputting the repairing sub-pixel data to the redundant line through an output buffer.

17. The method according to claim 14, further comprising the step of:
enabling the repair channel circuit.

18. A source driver applied to a liquid crystal display (LCD), which comprises first and second data lines, a controller and a data transmission path, wherein the controller is for outputting first image data, second image data and first repairing data, and the data transmission path comprises a redundant line interlacing with the data lines, the source driver comprising:
a first data channel circuit for receiving the first image data and outputting first sub-pixel data to the first data line;
a second data channel circuit for receiving the second image data and outputting second sub-pixel data to the second data line; and
a first repair channel circuit for receiving a first repair signal and outputting first repairing sub-pixel data to the data transmission path.

19. The source driver according to claim 18, wherein the data transmission path is selectively coupled to one of the data lines with an open defect.

20. The source driver according to claim 18, further comprising a channel selecting circuit, coupled to the first and second data channel circuits, for receiving the first and second sub-pixel data, selectively outputting one of the first and second sub-pixel data to one of the first and second data lines, and outputting the other of the first and second pixel data to the other of the first and second data lines.

21. The source driver according to claim 18, further comprising a second repair channel circuit for receiving second repairing data and outputting second repairing sub-pixel data, and a channel selecting circuit, which is coupled to the first and second repair channel circuits and is for receiving the first and second repairing sub-pixel data, and selectively outputting one of the first and second repairing sub-pixel data to the redundant line.

22. A signal transmission method of a timing controller applied to a liquid crystal display (LCD), the method comprising the steps of:
selectively inserting repairing data before or after a plurality of pieces of image data; and
sequentially outputting the repairing data and the pieces of image data, wherein the repairing data is the same as one of the pieces of image data.

23. The method according to claim 22, wherein the repairing data is inserted before the pieces of image data in the inserting step.

24. The method according to claim 22, wherein the repairing data is inserted after the pieces of image data in the inserting step.
